(19) United States
(12) Patent Application Publication
(10) Pub. No.: US 2025/0208102 A1
(43) Pub. Date: Jun. 26, 2025

(54) MONITORING ANALYSIS DEVICE AND MONITORING ANALYSIS METHOD

(71) Applicant: SHIMADZU CORPORATION, Kyoto (JP)

(72) Inventors: Yusuke NAGAI, Kyoto (JP); Yosuke IWATA, Kyoto (JP)

(73) Assignee: SHIMADZU CORPORATION, Kyoto (JP)

(21) Appl. No.: 18/849,481

(22) PCT Filed: Dec. 26, 2022
(86) PCT No.: PCT/JP2022/048026

§ 371 Date: Sep. 21, 2024

(30) Foreign Application Priority Data
Mar. 31, 2022 (JP) 2022-060716

(51) Int. Cl. G01N 30/86

(52) U.S. Cl. CPC G01N 30/8631; G01N 30/8679

(57) ABSTRACT

A monitoring analysis device includes a reaction product acquirer that sequentially acquires reaction products produced by a reaction device, an analyzer that sequentially analyzes the reaction products acquired by the reaction product acquirer, an analysis controller that causes the analyzer to execute a batch analysis in which a plurality of set analyses are sequentially executed according to a set analysis condition, and an analysis condition changer that, during execution of the batch analysis by the analyzer, and during or after execution of any analysis among the plurality of set analyses, is configured to change the set analysis condition for an analysis that is to be executed after the any analysis and is subject to a change.

### TECHNICAL FIELD

The present invention relates to a monitoring analysis device and a monitoring analysis method.

### BACKGROUND ART

In recent years, the Process Analytical Technology (PAT) has been introduced in the oil industry and the chemical industry. In the Process Analytical Technology, successively produced reaction products are analyzed and managed. With the Process Analytical Technology, a reaction product in the course of manufacturing can be continuously inspected and monitored. On the other hand, in the pharmaceutical industry, introduction of the Process Analytical Technology has been considered. Patent Document 1 describes a flow vial that is used in monitoring of a manufacturing process such as process chemistry. According to Patent Document 1, a sample (reaction product) to be analyzed can be introduced into an analysis device on-line with use of a flow vial.
[Patent Document 1] JP 6753536 B2

### SUMMARY OF INVENTION

### Technical Problem

In the analysis device, a batch analysis may be performed in order to efficiently perform an analysis multiple times. In the batch analysis, an analysis is successively performed a preset number of times according to preset analysis conditions.

On the other hand, in the Process Analytical Technology, the composition or properties of successively produced reaction products may be changed. In such a case, it may be desirable to change an analysis condition in order to improve the analysis accuracy. However, in a batch analysis, an analysis condition cannot be changed. In order to change the analysis condition for a batch analysis, it is necessary to temporarily end the batch analysis before the analysis of a set count ends and restart the analysis of the remaining count after an analysis worker changes the analysis condition. This increases an analysis period of time required for execution of the analysis of the set number of times and increases the labor of the analysis worker.

An object of the present invention is to provide a monitoring analysis device capable of efficiently improving analysis accuracy without increasing an analysis period of time for successively produced reaction products and labor of an analysis worker.

### Solution to Problem

A monitoring analysis device according to one aspect includes a reaction product acquirer that sequentially acquires reaction products produced by a reaction device, an analyzer that sequentially analyzes the reaction products acquired by the reaction product acquirer, an analysis controller that causes the analyzer to execute a batch analysis in which a plurality of set analyses are sequentially executed according to a set analysis condition, and an analysis condition changer that, during execution of the batch analysis by the analyzer, and during or after execution of any analysis among the plurality of set analyses, is configured to change the set analysis condition for an analysis that is to be executed after the any analysis and is subject to a change.

A monitoring analysis method according to another aspect includes sequentially acquiring reaction products produced by a reaction device, sequentially analyzing the acquired reaction products, causing the analyzer to execute a batch analysis in which a plurality of set analyses are sequentially executed according to a set analysis condition, and during execution of the batch analysis by the analyzer, and during or after execution of any analysis among the plurality of set analyses, changing the set analysis condition for an analysis that is to be executed after the any analysis and is subject to a change.

### Advantageous Effects of Invention

With the present invention, it is possible to efficiently improve analysis accuracy without increasing an analysis period of time for successively produced reaction products or increasing the labor of an analysis worker.

### [BRIEF DESCRIPTION OF THE DRAWINGS]

FIG. 1 is a diagram for explaining the configuration of a monitoring analysis device according to one embodiment.

FIG. 2 is a diagram showing one example of a chromatogram obtained by an analyzer.

FIG. 3 is a block diagram showing the functional configuration of a control device.

FIG. 4 is a flowchart showing one example of the behavior of the control device of FIG. 1.

FIG. 5 is a diagram showing one example of an operation image to be displayed on a screen of a display unit by the control device of FIG. 1.

FIG. 6 is a diagram showing one example of an operation image to be displayed on the screen of the display unit by the control device of FIG. 1.

FIG. 7 is a diagram showing one example of an operation image to be displayed on the screen of the display unit by the control device of FIG. 1.

FIG. 8 is a diagram showing one example of an operation image to be displayed on the screen of the display unit by the control device of FIG. 1.

FIG. 9 is a block diagram showing another example of the functional configuration of the control device.

FIG. 10 is a block diagram showing yet another example of the functional configuration of the control device.

FIG. 11 is a diagram showing one example of a production condition setting file screen for displaying a production condition setting file.

### DESCRIPTION OF EMBODIMENTS

A monitoring analysis device, a monitoring analysis device and a monitoring analysis method according to one embodiment of the present invention will be described below in detail with reference to the drawings.

### (1) Configuration of Monitoring Analysis Device

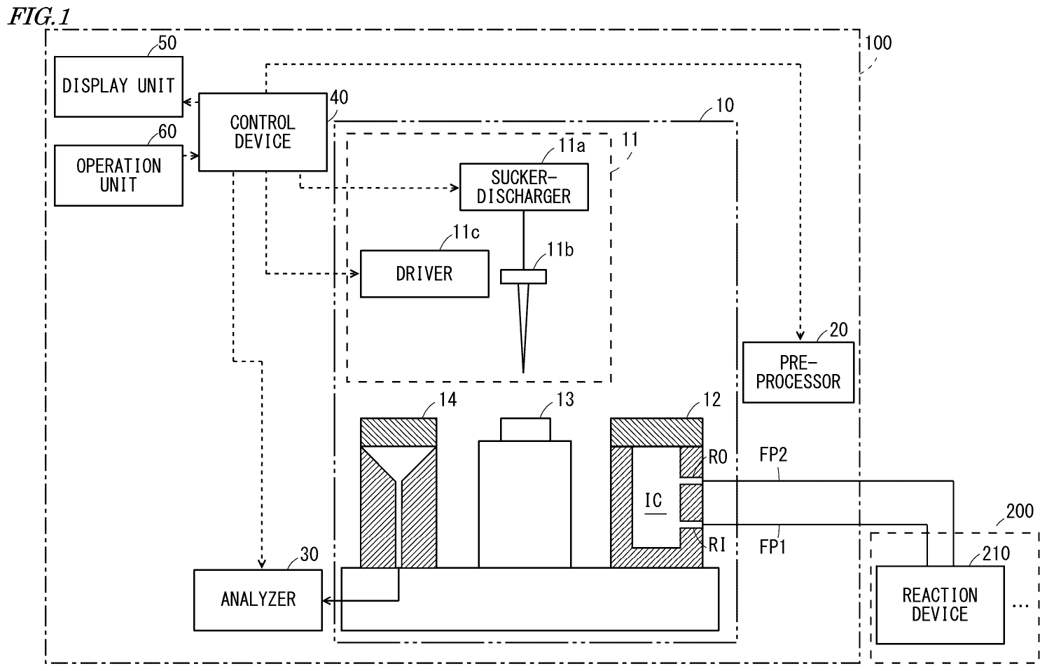

FIG. 1 is a diagram for explaining the configuration of the monitoring analysis device according to one embodiment. A reaction system 200 includes a plurality of reaction devices 210. In the plurality of reaction devices 210, different reaction products are sequentially produced. Here, the reaction products include not only final products but also include intermediate products. Further, the reaction products include a compound of a plurality of materials, a mixture of a plurality of materials, etc. For example, a reaction product is a mixture of a plurality of chemical agents.

The monitoring analysis device 100 is used to monitor reaction products produced by the plurality of reaction devices 210. The monitoring analysis device 100 includes a reaction product acquirer 10, a pre-processor 20, an analyzer 30, a control device 40, a display unit 50 and an operation unit 60. The reaction product acquirer 10 is an autosampler, for example. The reaction product acquirer 10 includes a suction-discharge system 11, a plurality of flow vials 12, one or a plurality of sample containers 13 and an injection port 14. The suction-discharge system 11 includes a sucker-discharger 11a, a sampling needle 11b and a driver 11c. The sucker-discharger 11a includes a suction mechanism and a discharge mechanism, and is configured to be capable of sucking liquid into the sampling needle 11b and discharging liquid to the outside of the sampling needle 11b. The driver 11c is configured to move the sampling needle 11b among the plurality of flow vials 12, the sample container 13, the injection port 14 and the below-mentioned pre-processor 20.

The plurality of flow vials 12 are provided to correspond to the plurality of reaction devices 210. In the example of FIG. 1, a single reaction device 210 and a single flow vial 12 are shown. An internal flow path IC, a first port (liquid inlet port) RI and a second port (liquid outlet port) RO are provided in the flow vial 12. One end of a first flow path FP1 and one end of a second flow path FP2 are connected to the first port RI and the second port RO, respectively. The reaction device 210 is connected to the other end of the first flow path FP1 and the other end of the second flow path FP2.

The pre-processor 20 includes devices each of which executes a pre-process on a reaction product such as a filtering device, a re-dissolving device, a diluting device, a quenching device and an adding device (not shown). The filtering device executes a filtering process of removing impurities and so on in a reaction product. The re-dissolving device executes a re-dissolving process of re-dissolving a reaction product by applying physical vibration such as ultrasonic waves to the reaction product. The diluting device executes a diluting process of diluting a reaction product. The quenching device executes a quenching process of suppressing the reaction progress of a reaction product. A gas-liquid separating device executes a gas-liquid separating process of separating a reaction product into gas and liquid. The adding device executes an adding process of adding an internal standard sample for creating a calibration curve in the analyzer 30. The pre-processor 20 executes one or a plurality of reaction-product processes on a reaction product in order to improve analysis accuracy. A reaction product on which a reaction-product process has been executed by the pre-processor 20 is referred to as a sample. The sample obtained by the pre-processor 20 is temporarily contained in the sample container 13.

The sample container 13 is used to temporarily contain the sample obtained by the pre-processor 20 before an analysis is executed by the analyzer 30. A sample to be supplied to the analyzer 30 is injected by the sampling needle 11b into the injection port 14. The sample that has been injected into the injection port 14 is supplied to the analyzer 30.

The analyzer 30 analyzes the sample that has been supplied from the injection port 14. The analyzer 30 includes a chromatograph such as a liquid chromatograph or a supercritical fluid chromatograph, and a mass spectrometer, for example. In the present embodiment, the analyzer 30 is a liquid chromatograph. The analyzer 30 produces a spectrum including at least one peak as an analysis result. In the present embodiment, the analyzer 30 produces a chromatogram as a spectrum representing the analysis result. In a case in which being a mass spectrometry device, the analyzer 30 produces a mass spectrum as a spectrum representing the analysis result.

The control device 40 includes a CPU (Central Processing Unit), a RAM (Random Access Memory), a ROM (Read Only Memory), an input/output I/F (interface) and a storage device. A control program is stored in the ROM or the storage device. The CPU controls the suction-discharge system 11, the pre-processor 20 and the analyzer 30 by executing the control program stored in the ROM or the storage device on the RAM. The display unit 50 and the operation unit 60 are connected to the control device 40. When a user (analysis worker) provides an instruction for analyzing a reaction product of the reaction device 210 through the operation unit, the control of the control device 40 is started.

In the present embodiment, a batch analysis is executed on a reaction product of the reaction device 210. In the present embodiment, a batch file including a plurality of analysis conditions, an analysis order and so on is registered in the control device 40 by the user.

The display unit 50 is a display device such as a liquid crystal display device that displays information relating to an analysis such as a result of an analysis executed in the analyzer 30. The operation unit 60 is an input device such as a keyboard, a mouse or a touch panel with which the user provides an instruction to the control device 40.

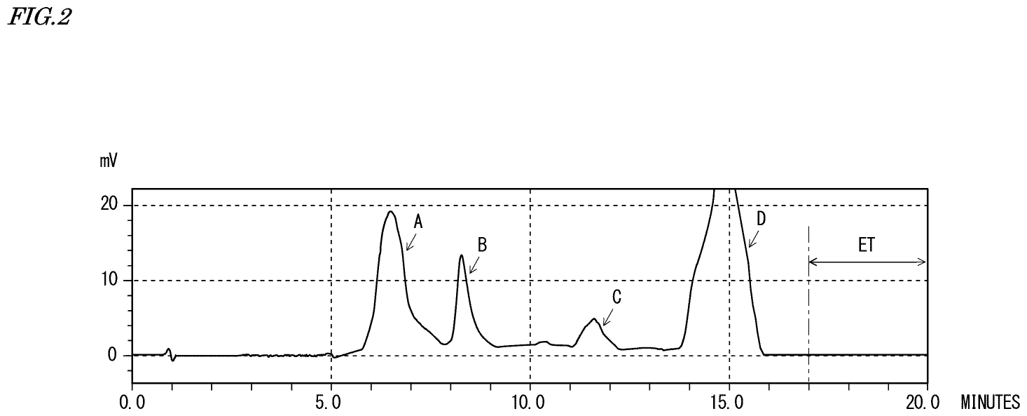

FIG. 2 is a diagram showing one example of a chromatogram obtained by the analyzer 30. Here, it is assumed that the chromatogram shown in FIG. 2 is obtained in any analysis during a batch analysis. The abscissa of the chromatogram indicates an elution time (retention time), and the ordinate indicates a signal intensity.

In the chromatogram shown in FIG. 2, peaks A to D appear. The peak D is saturated. It is considered that this is due to a change of a reaction product (a change in concentration, for example). In this case, it is not possible to execute a highly accurate analysis on the peak D. The chromatogram of FIG. 2 also includes a surplus period ET of time during which no peak appears after the appearance of the peak D. It is desired that the frequency of analysis is improved for a batch analysis for a reaction product. Therefore, it is desired to shorten an analysis period of time required for each analysis in a batch analysis.

In the monitoring analysis device 100 of the present embodiment, in regard to an analysis to be executed after an analysis in which the chromatogram shown in FIG. 2 is obtained, it is possible to suppress saturation of a peak and generation of the surplus period ET of time in the chromatogram.

### (2) Functional Configuration of Control Device 40

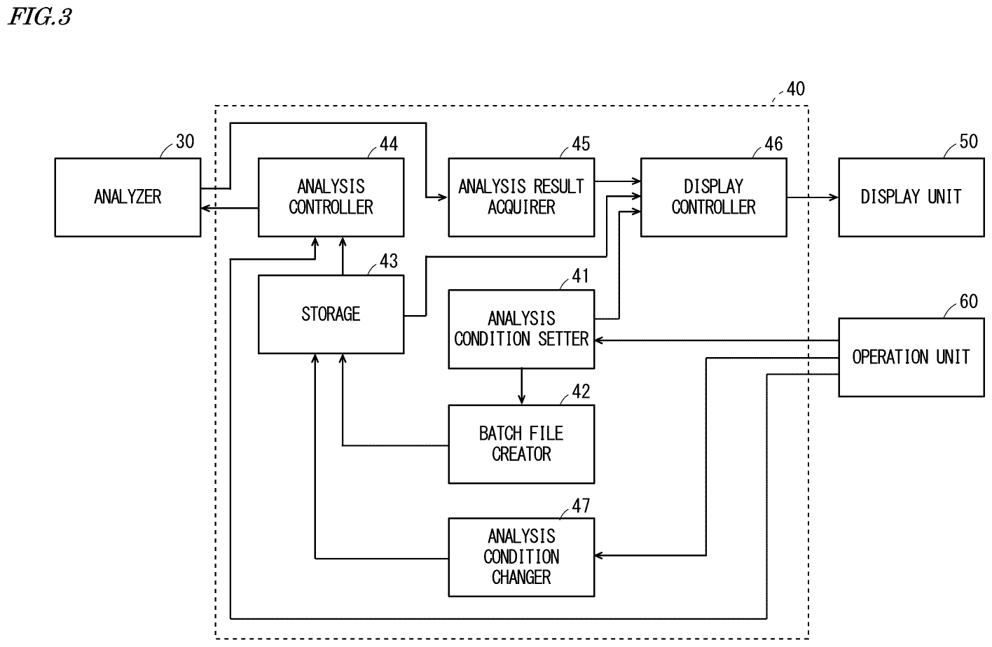

FIG. 3 is a block diagram showing the functional configuration of the control device 40. The control device 40 includes an analysis condition setter 41, a batch file creator 42, a storage 43, an analysis controller 44, an analysis result acquirer 45, a display controller 46 and an analysis condition changer 47. In the present embodiment, the plurality of constituent elements (41 to 47) of the control device 40 are implemented by execution of the control program stored in the ROM or the storage device by the CPU. Part or all of the plurality of constituent elements (41 to 47) of the control device 40 may be realized by hardware such as an electronic circuit.

The analysis condition setter 41 sets analysis conditions such as an analysis period of time required for an analysis in the analyzer 30 and a flow rate value of a mobile phase based on an operation performed on the operation unit 60, an inflow amount of a sample to the injection port 14 of FIG. 2, a sample dilution rate of the dilution device of the pre-processor 20. Further, the analysis condition setter 41 creates a method file including analysis conditions.

The batch file creator 42 creates a batch file including a method file in regard to a plurality of analyses. The storage 43 stores the batch file created by the batch file creator 42. The analysis controller 44 causes the analyzer 30 to execute a batch analysis based on the batch file stored in the storage 43. The analysis result acquirer 45 acquires an analysis result obtained by the analyzer 30 during execution of the batch analysis. The display controller 46 causes the display unit 50 to display various images required for an analysis by the analyzer 30. Further, the display controller 46 causes the display unit 50 to display the image representing an analysis result acquired by the analysis result acquirer 45. The analysis condition changer 47 changes an analysis condition in the batch file stored in the storage 43 based on an operation performed on the operation unit 60. Further, the analysis condition changer 47 causes the storage 43 to store a change in batch file as a history.

### (3) Behavior Example of Control Device 40

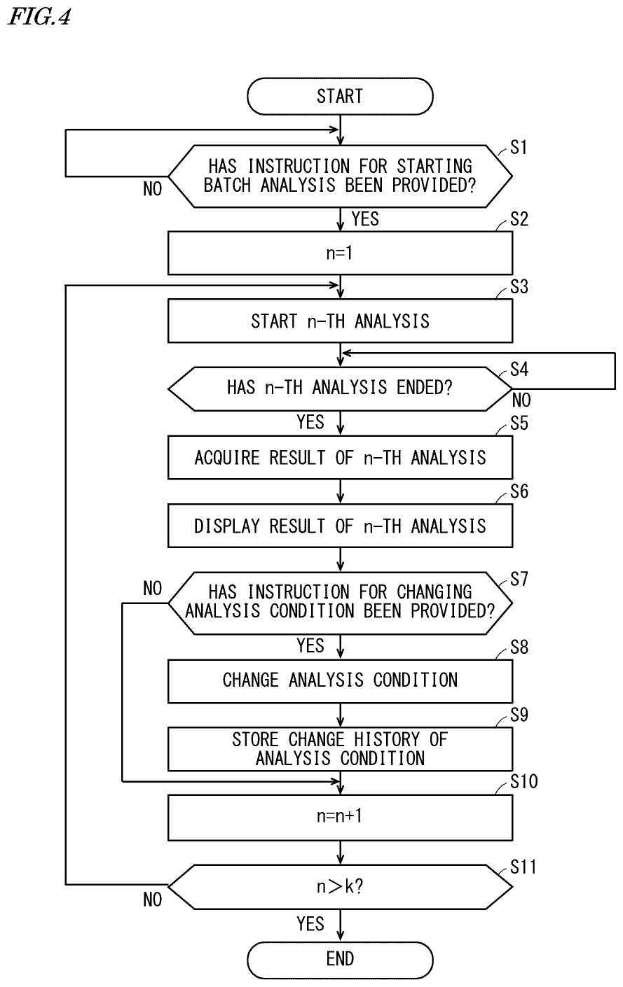

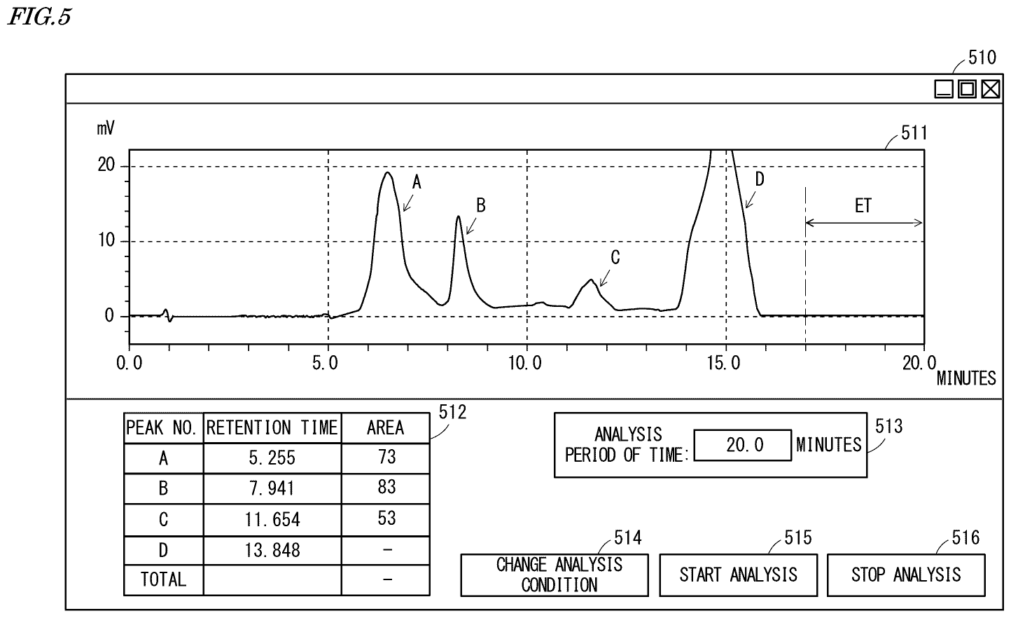

FIG. 4 is a flowchart showing one example of the behavior of the control device 40 of FIG. 1. FIGS. 5 to 8 are diagrams showing one example of operation images to be displayed on the screen of the display unit 50 by the control device 40 of FIG. 1. In the present example, in a batch file stored in the storage 43, it is set that an analysis is executed k times according to predetermined analysis conditions. K is an integer that is equal to or larger than 2.

First, the analysis controller 44 determines whether the user, using the operation unit 60, has instructed the analyzer 30 to start a batch analysis (step S1). In a case in which the user has not instructed the analyzer 30 to start a batch analysis, the analysis controller 44 waits. In a case in which the user has instructed the analyzer 30 to start a batch analysis, the analysis controller 44 set a variable n to 1 (step S2).

The analysis controller 44 causes the analyzer 30 to start the n-th analysis for a sample (step S3). Subsequently, the analysis controller 44 determines whether the n-th analysis by the analyzer 30 has ended (step S4). In a case in which the n-th analysis by the analyzer 30 has not ended, the analysis controller 44 waits until the n-th analysis by the analyzer 30 ends.

In a case in which the n-th analysis by the analyzer 30 has ended, the analysis result acquirer 45 acquires the result of the n-th analysis (step S5). The display controller 46 causes the display unit 50 to display the result of the n-th analysis acquired by the analysis result acquirer 45.

FIG. 5 shows one example of an analysis result display screen 510 showing the result of the n-th analysis displayed on the display unit 50. In the present example, the chromatogram shown in FIG. 2 is displayed as the analysis result for the n-th analysis.

The analysis result display screen 510 includes a chromatogram display area 511, a peak information display area 512, an analysis period-of-time display area 513, an analysis condition change button 514, an analysis start button 515 and an analysis stop button 516. The chromatogram display area 511 displays the chromatogram obtained in the n-th analysis by the analyzer 30. The peak information display area 512 displays the information about peaks detected in the chromatogram in the chromatogram display area 511. In the example of FIG. 5, the values for retention times and areas in regard to the peaks A to D detected in the chromatogram are respectively displayed. Since the peak D is saturated, “-” is displayed as the value for the area of the peak D.

In the analysis period-of-time display area 513, the analysis period of time for the n-th analysis is displayed. In the example of FIG. 5, “20.0 minutes” is displayed as the analysis period of time for the n-th analysis. As described above, the chromatogram of FIG. 5 includes a surplus period ET of time of 17.0 to 20.0 minutes which is not required as an analysis period of time. The analysis condition change button 514 is operated for changing of an analysis condition in the batch file stored in the storage 43 of FIG. 3. The analysis condition change button 514 can be operated even during an analysis. When an analysis condition for the n+1-th analysis is changed right before the n-th analysis ends, a change may not be made in time. Therefore, the restriction that an analysis condition for the next analysis cannot be changed during an analysis may be provided. The analysis start button 515 is operated for starting of an analysis being stopped. The analysis stop button 516 is operated for stopping of an analysis being executed.

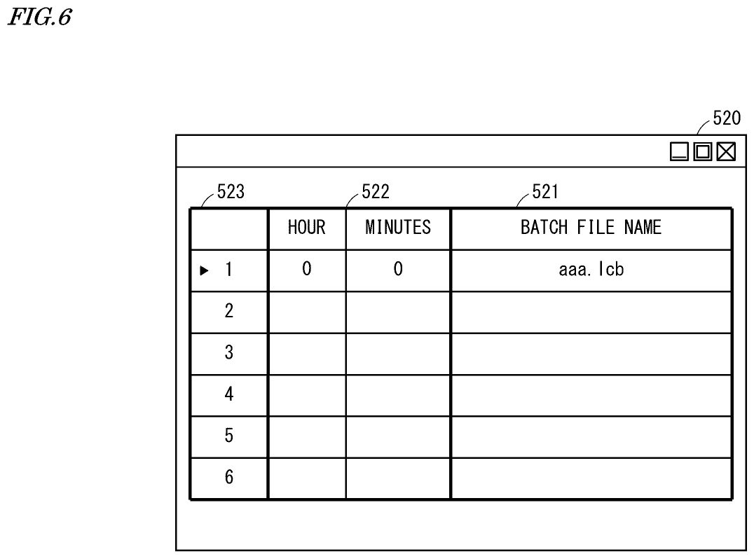

When the user operates the analysis condition change button 514 through the operation unit 60, the display controller 46 displays a batch file selection screen. FIG. 6 shows one example of the batch file selection screen 520 displayed on the display unit 50. The batch file selection screen 520 includes a batch file name display field 521, a start point-in-time display field 522 and an order display field 523.

In the order display field 523, the execution order for batch files to be executed by the analyzer 30 is displayed. In the start point-in-time display field 522, the start point-in-time of a batch analysis based on each batch file is displayed. In the example of FIG. 6, the batch analysis based on the first batch file is started later than 0:00. In the batch file name display field 521, the name of a batch file (batch file name) for execution of each batch analysis is displayed in a selectable manner. In the example of FIG. 6, the first batch analysis is executed based on the batch file having the batch file name “aaa.lcb.” In the example of FIG. 6, the start point-in-time and the batch file name corresponding to each of the batch analyses to be executed secondly and subsequently are not registered.

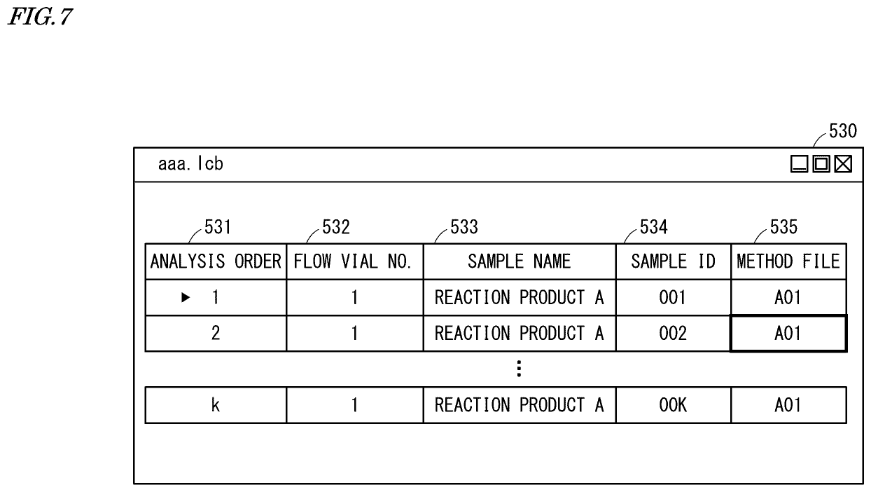

Next, when the batch file name “aaa.lcb” in the batch file selection screen 520 is selected, the display controller 46 displays the batch file information selection screen corresponding to the batch file having the batch file name “aaa.lcb.” FIG. 7 shows one example of the batch file information selection screen 530. The batch file information selection screen 530 includes an analysis order display field 531, a flow vial number display field 532, a sample name display field 533, a sample ID display field 534 and a method file display field 535.

In the analysis order display field 531, the order of analyses included in the batch file is displayed. In the present example, the analysis order for the first to k-th analyses is displayed. The flow vial number display field 532 displays the number (flow vial number) of the flow vial 12 (see FIG. 1) from which a reaction product to be analyzed can be obtained. The sample name display field 533 displays the name (sample name) for specifying the type of a reaction product to be analyzed. The sample ID display field 534 displays the sample ID number for identifying a sample to be analyzed in each analysis. In the method file display field 535, the method file name for specifying the method file including analysis conditions for each analysis to be performed by the analyzer 30 is displayed in a selectable manner. In the example of FIG. 2, the method file name “A01” of the method file for the second analysis is selected. As shown in FIG. 7, in an initial state, the same method file is used for a plurality of analyses in the batch analysis.

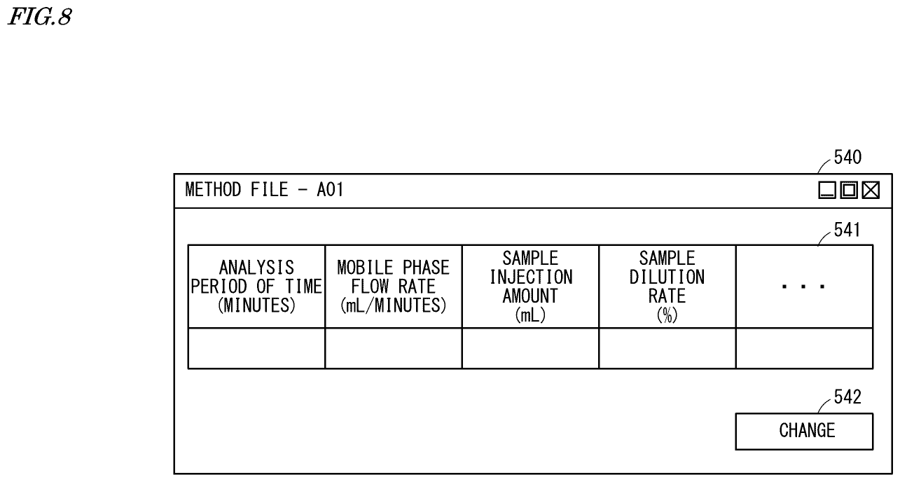

Next, when the method file name “A01” is selected, the display controller 46 displays an analysis condition change screen. FIG. 8 shows one example of the analysis condition change screen 540. The analysis condition change screen 540 includes an analysis condition input field 541 and a change button 542. In the analysis condition input field 541, input fields for values for analysis conditions such as an analysis period of time, a flow rate value of a mobile phase, an inflow amount of a sample and a sample dilution rate. The user inputs a value for a desired analysis condition using the operation unit 60. For example, in the chromatogram shown in FIG. 5, in a case in which wishing to eliminate a surplus period ET of time, the user changes the value for the analysis period of time to a smaller value or changes the value for the mobile phase flow rate to a larger value. Further, in a case in which wishing to suppress the saturation of the peak D, the user changes the value for a sample injection amount to a smaller value or changes the value for the sample dilution rate to a larger value. Finally, after changing the value for the desired analysis condition, the user selects the change button 542. Thus, the analysis condition changer 47 changes an analysis condition for the batch file stored in the storage 43. Further, the display controller 46 causes the display unit 50 to display the analysis result display screen D1 shown in FIG. 5 again.

In FIG. 4, the analysis condition changer 47 determines whether the user has provided an instruction for changing an analysis condition for a batch file stored in the storage 43 by using the operation unit 60 (step S7). In a case in which the instruction for changing an analysis condition for a batch file is not provided, the analysis condition changer 47 proceeds to the step S10, described below. In a case in which the instruction for changing an analysis condition for a batch file is provided, the analysis condition changer 47 changes the analysis condition for the batch file stored in the storage 43 to an analysis condition input to the analysis condition input field 541 of FIG. 8 (step S8). At this time, in the method file, the values for the analysis condition that is the same as the analysis condition that has been changed are also changed at the same time. Further, the analysis condition changer 47 causes the storage 43 to store the change history of an analysis condition (step S9). Specifically, the analysis condition changer 47 causes the storage 43 to store the analysis condition before the change and the analysis condition after the change in a chronological order.

Subsequently, the analysis controller 44 adds 1 to the variable n (step S10). Further, the analysis controller 44 determines whether the variable n is larger than an analysis count k (step S11). In a case in which the variable n is equal to or smaller than the analysis count k, the analysis controller 44 returns to the step S3. Thus, the process of the above-mentioned steps S3 to S11 is repeated, and the (n+1)-th analysis is executed. In the step S11, in a case in which the variable n is larger than the analysis count k, the behavior of the control device 40 ends. Thus, the batch analysis ends.

### (4) Effects of Embodiments

With the monitoring analysis device 100 of the above-mentioned embodiment, it is possible to change an analysis condition during execution of a batch analysis. Thus, even in a case in which the composition or property of a reaction product acquired by the reaction product acquirer 10 is changed, it is possible to obtain an analysis result corresponding to the change of the reaction product without interrupting or ending a batch analysis. Therefore, it is possible to improve analysis accuracy without increasing an analysis period of time for successively produced reaction products.

Further, the user can determine whether to change an analysis condition for each of subsequent analyses while viewing the analysis result displayed on the display unit 50. Further, the analysis conditions displayed on the display unit 50 can be visually identified. Thus, it is possible to easily set an analysis condition.

Further, it is possible to easily change an analysis condition in a batch analysis by changing the contents of a batch file stored in the storage 43.

Further, because the history of changes of analysis conditions that are made during or after execution of a batch analysis is stored in the storage 43, it is possible to improve the reliability of the batch analysis.

### (5) Other Embodiments

(5-1) While an analysis condition is changed in a case in which an instruction for changing an analysis condition is provided during execution of a batch analysis in the above-mentioned embodiment, the present invention is not limited to this. For example, an analysis condition may be automatically changed without provision of an instruction for changing an analysis condition during execution of a batch analysis.

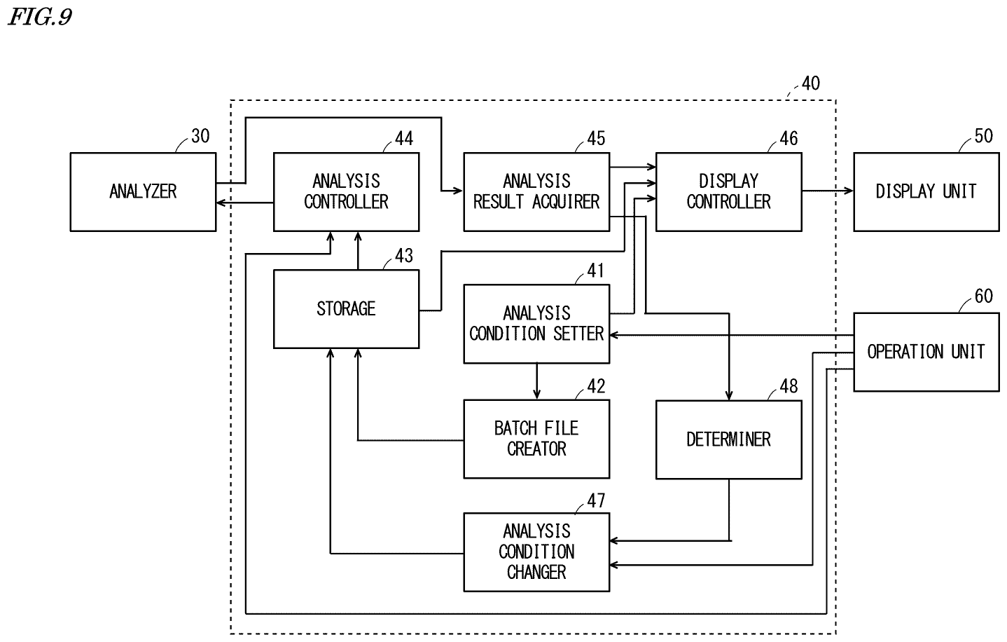

FIG. 9 is a block diagram showing another example of the functional configuration of the control device 40. In addition to the plurality of constituent elements (41 to 47) of the control device 40 of FIG. 3, a determiner 48 is further provided.

The determiner 48 determines whether the value for a specific item in an analysis result acquired by the analysis result acquirer 45 exceeds a predetermined threshold value. In this case, the analysis condition changer 47 changes the analysis condition for a batch file stored in the storage 43 such that the value for the specific item does not exceed the predetermined threshold value.

For example, the determiner 48 may determine whether the area value for one peak exceeds a predetermined value. In this case, the analysis condition changer 47 changes an analysis condition (a sample injection amount, a sample dilution rate or the like) such that the area value for one peak does not exceed the predetermined threshold value.

Further, the determiner 48 may determine whether the height value for one peak exceeds a predetermined value. In this case, the analysis condition changer 47 may change an analysis condition (a sample injection amount, a sample dilution rate or the like) such that the height for one peak does not exceed the predetermined threshold value. In this case, the analysis condition changer 47 changes an analysis condition (a sample injection amount, a sample dilution rate or the like) such that the height value for one peak does not exceed the predetermined threshold value.

Further, the determiner 48 may determine whether the value representing the surplus period ET of time in the above-mentioned embodiment exceeds a predetermined value. In this case, the analysis condition changer 47 changes an analysis condition (an analysis period of time or a mobile phase flow rate) such that the surplus period ET of time does not exceed the predetermined value.

In these cases, it is possible to automatically change an analysis condition during execution of a batch analysis. This further reduces a work load on the user.

(5-2) While an analysis condition for a next analysis is changed after execution of one analysis during execution of a batch analysis in the above-mentioned embodiment, the present invention is not limited to this. For example, during execution of one analysis of a batch analysis, an analysis condition for the analysis that is to be executed later than the analysis that is being executed may be changed. Further, during execution of a batch analysis, during or after execution of one analysis, an analysis condition for any analysis that is to be executed subsequently may be changed.

(5-3) While a batch file is stored in the storage 43 in the above-mentioned embodiment, a batch file to be executed by the analyzer 30 may be stored in an external storage device such as a cloud. In this case, the analysis condition changer 47 may change an analysis condition for a batch file stored in the external storage device.

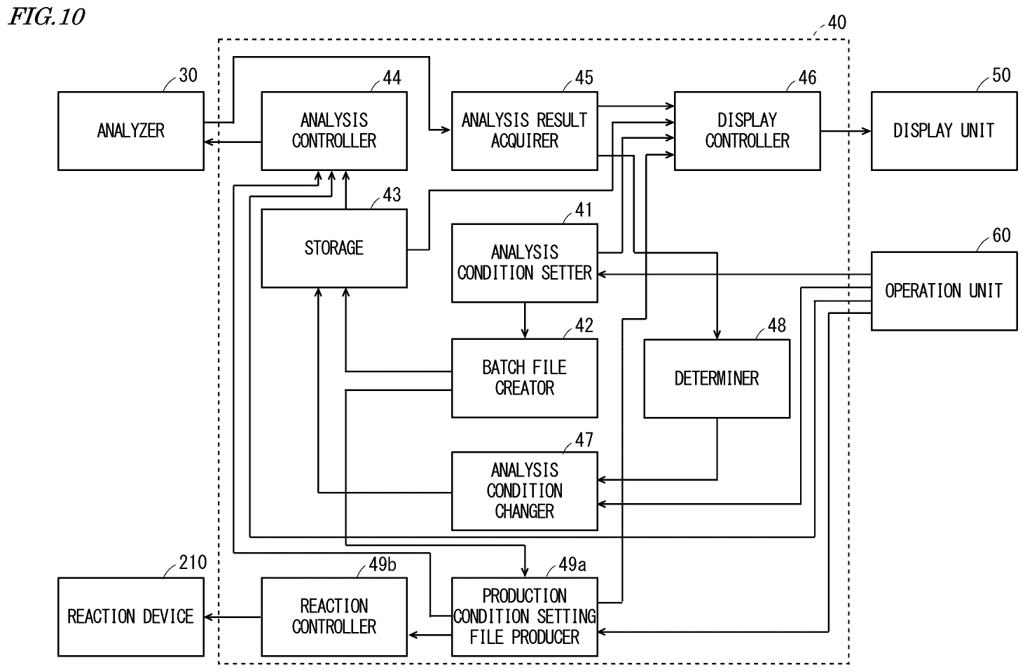

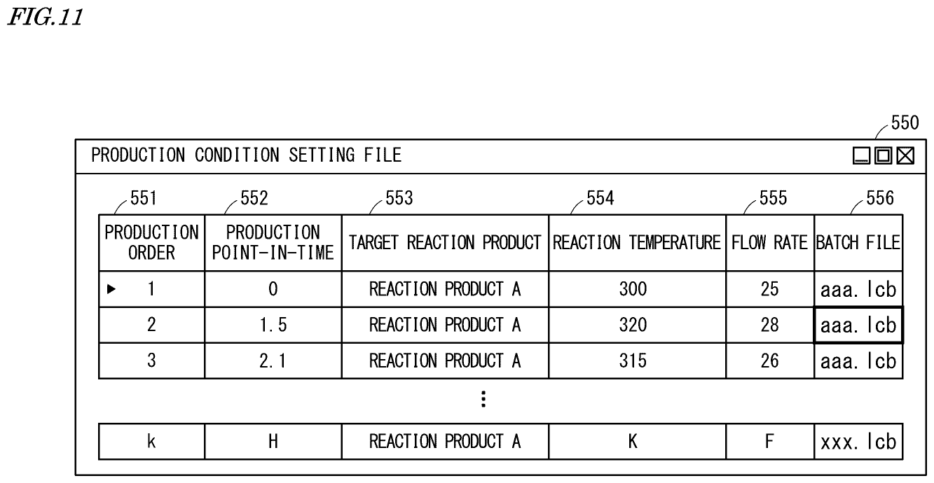

(5-4) While controlling the constituent elements of the monitoring analysis device 100 in FIG. 1 of the above-mentioned embodiment, the control device 40 may further control the plurality of reaction devices 210 of the reaction system 200. FIG. 10 is a block diagram showing yet another example of the functional configuration of the control device 40. FIG. 11 is a diagram showing one example of a production condition setting file screen for displaying a production condition setting file. In a production condition setting file, the production conditions for production of each target reaction product by the reaction device 210 and the batch file used for an analysis of each target reaction product are written.

In FIG. 10, the control device 40 further includes a production condition setting file producer 49a and a reaction controller 49b. The production condition setting file producer 49a sets a production condition for each target reaction product in a production condition setting file based on an operation performed on the operation unit 60 by the user, and sets a batch file created by the batch file creator 42. The display controller 46 causes the production condition setting file display screen 550 to display a production condition setting file produced by the production condition setting file producer 49a. The reaction controller 49b controls the reaction device 210 based on the production conditions set in the production condition setting file producer 49a, and controls the analyzer 30 using the batch file corresponding to each target reaction product.

The production condition setting file screen 550 of FIG. 11 includes a production order display field 551, a production period-of-time display field 552, a target reaction product display field 553, a reaction temperature display field 554, a flow rate display field 555 and a batch file display field 556.

In the production order display field 551, the production order of target reaction products according to production conditions is displayed. In the production point-in-time display field 522, the point in time at which production of each target reaction product is started is displayed. In the target reaction product display field 553, each target reaction product is displayed. In the reaction temperature display field 554, a reaction temperature is displayed as one production condition for each target reaction product. In the flow rate display field 555, the flow rate of a reaction material in the reaction device 210 is displayed as one production condition for each target reaction product. In the batch file display field 556 used for an analysis of each target reaction product, a batch file to be executed by the analyzer 30 for the analysis of each target reaction product is displayed. In the present example, the target reaction products may be sequentially produced according to a plurality of production conditions in the order displayed in the production order display field 551 of the production condition setting file. The target reaction products may be produced according to a plurality of production conditions in the order designated by the user.

Here, when the batch file name “aaa.lcb” corresponding to the second production condition for the production condition setting file is selected, for example, the display controller 46 displays the batch file information selection screen 530 (see FIG. 7) corresponding to the batch file having the batch file name “aaa.lcb.” The behavior after that is similar to that of the above-mentioned embodiment. As described in the above-mentioned embodiment, in a case in which the method file (analysis condition) included in the batch file “aaa.lcb” corresponding to the production condition for the target reaction product that is to be produced secondly is changed, the method file of the batch file corresponding to the target reaction products that are to be produced secondly and subsequently after that are also changed. In this manner, when the method file of any batch file is changed, not only the method file for a target reaction product to be produced according to the production conditions corresponding to the changed batch file but also the method file for target reaction products to be subsequently produced according to production conditions can be changed.

### (6) Correspondences Between Constituent Elements in Claims and Parts in Preferred Embodiments

In the following paragraphs, non-limiting examples of correspondences between various elements recited in the claims below and those described above with respect to various preferred embodiments of the present disclosure are explained. In the above-mentioned embodiment, the storage 43 is an example of a batch file storage and a history storage.

### (7) Aspects

It will be appreciated by those skilled in the art that the exemplary embodiments described above are illustrative of the following aspects.

(Item 1) A monitoring analysis device according to one aspect includes a reaction product acquirer that sequentially acquires reaction products produced by a reaction device, an analyzer that sequentially analyzes the reaction products acquired by the reaction product acquirer, an analysis controller that causes the analyzer to execute a batch analysis in which a plurality of set analyses are sequentially executed according to a set analysis condition, and an analysis condition changer that, during execution of the batch analysis by the analyzer, and during or after execution of any analysis among the plurality of set analyses, is configured to change the set analysis condition for an analysis that is to be executed after the any analysis and is subject to a change.

With the monitoring analysis device according to item 1, it is possible to change an analysis condition during execution of a batch analysis. Thus, even in a case in which the composition or property of sequentially acquired reaction products changes, it is possible to obtain an analysis result corresponding to the change of the reaction products without interrupting or ending a batch analysis. Therefore, it is possible to efficiently improve analysis accuracy without increasing an analysis period of time required for successively produced reaction products or increasing the labor of an analysis worker.

(Item 2) The monitoring device according to item 1, wherein the analysis condition changer may be characterized by, in a case in which an analysis condition for the analysis that is subject to a change is changed, changing the set analysis condition for the analysis to be executed after execution of the analysis that is subject to a change.

With the monitoring analysis device according to item 2, in a batch analysis, it is possible to change an analysis condition for an analysis to be executed after an analysis subject to a change. As a result, it is possible to reduce an increase in analysis period of time required for successively produced reaction products and an increase in labor of the analysis worker.

(Item 3) The monitoring analysis device according to item 1 or 2, may further include an analysis result acquirer that acquires a result of each analysis from the analyzer during execution of the batch analysis by the analyzer, and a display controller that causes a display unit to display a result of each analysis during execution of the batch analysis by the analyzer.

With the monitoring analysis device according to item 3, the user can determine whether to change an analysis condition for an analysis to be executed subsequently and determine how to change the analysis condition while viewing the result of each analysis.

(Item 4) The monitoring analysis device according to item 3, wherein the display controller may cause the display unit to display the set analysis condition in a changeable manner, and the analysis condition changer may change the set analysis condition to an analysis condition to which the set analysis condition has been changed in the display unit.

With the monitoring analysis device according to item 4, the user can visually identify set analysis conditions using the display unit, and can easily change an analysis condition by changing the display in the display unit.

(Item 5) The monitoring analysis device according to any one of items 1 to 4, may further include a batch file storage that stores a batch file including the set analysis condition in the batch analysis, wherein the analysis controller may cause the analyzer to execute the batch analysis based on the stored batch file, and may be configured to be capable of, during execution of the batch analysis by the analyzer, changing an analysis condition for an analysis to be executed after the any analysis in the batch file stored in the batch file storage.

With the monitoring analysis device according to item 5, it is possible to easily change an analysis condition in a batch analysis by changing the contents of a batch file stored in the batch file storage.

(Item 6) The monitoring analysis device according to any one of items 1 to 5, may further include a history storage that stores a change history of the analysis condition changed by the analysis condition changer.

With the monitoring analysis device according to item 6, because the change history of an analysis condition, which is changed during or after execution of a batch analysis, is stored, it is possible to improve the reliability of the batch analysis.

(Item 7) The monitoring analysis device according to any one of items 1 to 6, may further include a determiner that determines whether a value for a specific item in an analysis result in regard to one analysis exceeds a predetermined threshold value, wherein the analysis condition changer, in a case in which the determiner determines that the value exceeds the threshold value, may change the analysis condition such that a value for the specific item does not exceeds the threshold value in an analysis to be executed after the one analysis.

With the monitoring analysis device according to item 7, an analysis condition is automatically changed such that the value for a specific item in an analysis result provided by the analyzer does not exceed the threshold value in the subsequent analysis. This reduces a work load on the user.

(Item 8) The monitoring analysis device according to item 7, wherein the analyzer produces a spectrum including at least one peak as the analysis result, a value for the specific item includes an area value for one peak in the spectrum produced by the analyzer, the determiner determines whether the area value for one peak in the spectrum produced by the analyzer exceeds the threshold value, and the analysis condition changer changes the analysis condition such that an area value for the one peak does not exceed the threshold value in an analysis to be executed after the one analysis.

With the monitoring analysis device according to item 8, an analysis condition is automatically changed such that the area value for one peak in a spectrum produced by the analyzer does not exceed the threshold value in the subsequent analysis. This reduces a work load on the user.

(Item 9) The monitoring analysis device according to item 7, wherein the analyzer may produce a spectrum including at least one peak as the analysis result, a value for the specific item may include a height value for one peak in the spectrum produced by the analyzer, the determiner may determine whether the height value for one peak in the chromatogram obtained as the analysis result exceeds the predetermined threshold value, and the analysis condition changer may change the analysis condition such that a height value for the one peak does not exceed the threshold value in an analysis to be executed after the one analysis.

With the monitoring analysis device according to item 9, an analysis condition is automatically changed such that the height value for one peak in a spectrum produced by the analyzer does not exceed the threshold value in the subsequent analysis. This reduces a work load on the user.

(Item 10) The monitoring analysis device according to item 7, wherein the analyzer may produce a spectrum including at least one peak as the analysis result, a value for the specific item may include a value for a surplus period of time indicating a period of time from a point in time at which a last peak appears to a point in time at which an analysis ends in the spectrum produced by the analyzer, the determiner may determine whether the surplus period of time exceeds the threshold value, and the analysis condition changer may change the analysis condition such that a value for the surplus period of time does not exceed the threshold value.

(Item 11) The monitoring analysis device according to any one of items 1 to 10, may further include a reaction controller that controls the reaction device such that reaction products are sequentially produced based on a plurality of set production conditions, wherein analysis conditions for the batch analysis may be respectively associated with the plurality of production conditions, and the analysis condition changer, in a case in which an analysis condition corresponding to one production condition is changed, may change the set analysis condition for the analysis that corresponds to the one production condition and is subject to a change, and the set analysis condition for an analysis corresponding to a production condition for subsequent production.

With the monitoring analysis device according to item 11, it is possible to change an analysis condition for a batch analysis for a reaction product to be produced according to a plurality of production conditions at any point in time.

(Item 12) A monitoring analysis method according to another aspect includes sequentially acquiring reaction products produced by a reaction device, sequentially analyzing the acquired reaction products, causing the analyzer to execute a batch analysis in which a plurality of set analyses are sequentially executed according to a set analysis condition, and during execution of the batch analysis by the analyzer, and during or after execution of any analysis among the plurality of set analyses, changing the set analysis condition for an analysis that is to be executed after the any analysis and is subject to a change.

With the monitoring analysis method according to item 12, it is possible to change an analysis condition during execution of a batch analysis. Thus, even in a case in which the composition or property of sequentially acquired reaction products is changed, it is possible to obtain an analysis result corresponding to the change of a reaction product without interrupting or ending a batch analysis. Therefore, it is possible to improve analysis accuracy without increasing an analysis period of time for successively produced reaction products.

1. A monitoring analysis device comprising:
a reaction product acquirer that sequentially acquires reaction products produced by a reaction device;
an analyzer that sequentially analyzes the reaction products acquired by the reaction product acquirer;
an analysis controller that causes the analyzer to execute a batch analysis in which a plurality of set analyses are sequentially executed according to a set analysis condition; and
an analysis condition changer that, during execution of the batch analysis by the analyzer, and during or after execution of any analysis among a plurality of set analyses, is configured to change the set analysis condition for an analysis that is to be executed after the any analysis and is subject to a change.

2. The monitoring device according to claim 1, wherein
the analysis condition changer is characterized by changing the set analysis condition for the analysis to be executed after execution of the analysis that is subject to a change.

3. The monitoring analysis device according to claim 1, further comprising:
an analysis result acquirer that acquires a result of each analysis from the analyzer during execution of the batch analysis by the analyzer; and
a display controller that causes a display unit to display a result of each analysis during execution of the batch analysis by the analyzer.

4. The monitoring analysis device according to claim 3, wherein
the display controller causes the display unit to display the set analysis condition in a changeable manner, and the analysis condition changer changes the set analysis condition to an analysis condition to which the set analysis condition has been changed in the display unit.

5. The monitoring analysis device according to claim 1, further comprising a batch file storage that stores a batch file including the set analysis condition in the batch analysis, wherein
the analysis controller causes the analyzer to execute the batch analysis based on the stored batch file, and
the analysis condition changer is configured to be capable of, during execution of the batch analysis by the analyzer, changing an analysis condition for an analysis to be executed after the any analysis in the batch file stored in the batch file storage.

6. The monitoring analysis device according to claim 1, further comprising a history storage that stores a change history of the analysis condition changed by the analysis condition changer.

7. The monitoring analysis device according to claim 1, further comprising a determiner that determines whether a value for a specific item in an analysis result in regard to one analysis exceeds a predetermined threshold value, wherein
the analysis condition changer, in a case in which the determiner determines that the value exceeds the threshold value, changes the analysis condition such that a value for the specific item does not exceeds the threshold value in an analysis to be executed after the one analysis.

8. The monitoring analysis device according to claim 7, wherein
the analyzer produces a spectrum including at least one peak as the analysis result,
a value for the specific item includes an area value for one peak in the spectrum produced by the analyzer,
the determiner determines whether the area value for one peak in the spectrum produced by the analyzer exceeds the threshold value, and
the analysis condition changer changes the analysis condition such that an area value for the one peak does not exceed the threshold value in an analysis to be executed after the one analysis.

9. The monitoring analysis device according to claim 7, wherein
the analyzer produces a spectrum including at least one peak as the analysis result,
a value for the specific item includes a height value for one peak in the spectrum produced by the analyzer,
the determiner determines whether the height value for one peak in the chromatogram obtained as the analysis result exceeds the predetermined threshold value, and
the analysis condition changer changes the analysis condition such that a height value for the one peak does not exceed the threshold value in an analysis to be executed after the one analysis.

10. The monitoring analysis device according to claim 7, wherein
the analyzer produces a spectrum including at least one peak as the analysis result,
a value for the specific item includes a value for a surplus period of time indicating a period of time from a point in time at which a last peak appears to a point in time at which an analysis ends in the spectrum produced by the analyzer,
the determiner determines whether the surplus period of time exceeds the threshold value, and
the analysis condition changer changes the analysis condition such that a value for the surplus period of time does not exceed the threshold value.

11. The monitoring analysis device according to claim 1, further comprising a reaction controller that controls the reaction device such that reaction products are sequentially produced based on a plurality of set production conditions, wherein
analysis conditions for the batch analysis are respectively associated with the plurality of production conditions, and
the analysis condition changer, in a case in which an analysis condition corresponding to one production condition is changed, changes the set analysis condition for the analysis that corresponds to the one production condition and is subject to a change, and the set analysis condition for an analysis corresponding to a production condition for subsequent production.

12. A monitoring analysis method including:
sequentially acquiring reaction products produced by a reaction device;
sequentially analyzing the acquired reaction products;
causing the analyzer to execute a batch analysis in which a plurality of set analyses are sequentially executed according to a set analysis condition; and
during execution of the batch analysis by the analyzer, and during or after execution of any analysis among a plurality of set analyses, changing the set analysis condition for an analysis that is to be executed after the any analysis and is subject to a change.

13. The monitoring analysis device according to claim 7, wherein
the analyzer produces a chromatogram including at least one peak as the analysis result,
a value for the specific item includes a height value for one peak in the chromatogram produced by the analyzer,
the determiner determines whether the height value for one peak in the chromatogram obtained as the analysis result exceeds the predetermined threshold value, and
the analysis condition changer changes the analysis condition such that a height value for the one peak does not exceed the threshold value in an analysis to be executed after the one analysis.
